(19) United States
(12) Patent Application Publication
(10) Pub. No.: US 2010/0080919 A1
(43) Pub. Date: Apr. 1, 2010

(54) METHOD FOR PRODUCING SINGLE OR MULTIPLY COATED SUBSTRATES WITH THE AID OF A COLOURED COATING COMPOSITION COMPRISING A BINDING AGENT FOR ADHESION

(75) Inventors: Erich KRUMBACHER, Ludwigshafen (DE); Oliver Birkert, Fussgoennheim (DE); Martin Schachtl, Buch am Erlbach (DE); Christoph Hamers, Ludwigshafen (DE); Martin Tietz, Heidenheim (DE); Uwe Froehlich, Langenau (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF Aktiengesellschaft, Ludwigshafen (DE)

(21) Appl. No.: 12/631,414

(22) Filed: Dec. 4, 2009

Related U.S. Application Data
(62) Division of application No. 11/575,410, filed on Mar. 16, 2007.

(30) Foreign Application Priority Data
Sep. 17, 2004 (DE) 10 2004 045 172.9

(51) Int. Cl. B05D 1/30

(52) U.S. Cl. 427/420

(57) ABSTRACT

A coating slip composition which can be applied by the curtain coating method to substrates to be coated, for example base paper or cardboard, is described. The substrate, which may be base paper or cardboard, is coated with one or more free-falling liquid curtains, a binder being added to the coating liquid. The binder is selected from the group comprising styrene/butadiene latex binders, styrene/acrylate latex binders, styrene/butadiene/acrylonitrile latex binders, styrene/maleic anhydride binders and styrene/acrylate/maleic anhydride binders, the binder having a particle size of <130 nm.

### CROSS REFERENCE TO RELATED APPLICATIONS

This application is a divisional application of prior U.S. patent application Ser. No. 11/575,419, the disclosure of which is incorporated by reference in its entirety. U.S. Ser. No. 11/575,419 is a National Stage of PCT/EP05/09980 filed on Sep. 16, 2005 which claims the benefit of priority under 35 U.S.C §119 from Germany Patent Application No. 10 2004 045 172.9, filed Sep. 17, 2004, the disclosures of which are incorporated herein by reference in their entireties.

### BACKGROUND OF THE INVENTION

1. Field of the Invention

The present invention relates to a process for the production of singly and/or multiply coated substrates, for example paper or board, except for photographic papers and self-adhesive labeling papers, which are especially suitable for printing, packaging and inscribing, the substrate being coated in particular with one or more freely falling liquid curtains, the freely falling liquid curtains being formed by a coating slip composition which comprises a binder having particularly high binding power.

2. Description of the Related Art

In the photographic industry, curtain coating is a known process for coating substrates. However, the emulsions or liquids used to date as a coating have a low solids content and a low viscosity; moreover, the application rate has very low values which at present are below 600 m/min. On the other hand, in the production of graphic arts papers, pigmented suspensions having a high solids content and high viscosities are used, in contrast to the suspensions used in the photographic industry. Furthermore, graphic arts papers are generally produced by means of blade coating or film pressing at speeds substantially above 1000 m/min.

Both the blade coating method and the film press coating method have specific disadvantages which affect the quality of the coated substrates obtained, for example base paper or board. In the case of the blade coating method, the aggregation of particles, induced by the high shear rates under the blade, can lead to stripes on the paper coat, which adversely affect the resulting paper or cardboard surface quality. Furthermore, the coating slips used in the graphic arts industry impose a stress on the blade to such an extent that it has to be replaced frequently in order to ensure constant coat quality.

Moreover, the coat distribution on the paper or cardboard surface is influenced by irregularities of the substrate. A nonuniform coat distribution on the paper or substrate surface leads to poor printed copies, for example mottling phenomena (cloudy print).

The film press coating method used to date for the production of graphic arts papers requires a narrowly dimensioned operating window which is determined substantially by the factors of substrate surface property, substrate porosity (absorption behavior) and coating slip solids content. This narrowly limited operating window has to be redetermined for each web speed, i.e. for each coating speed and for each coat weight. In the case of nonoptimized coating slip receptors used in the film press coating method, a nonuniform film splitting pattern may occur on the surface of the substrate, whether paper or cardboard, which pattern in turn results in poor printability. In the film press coating method, small drops may furthermore become detached during coating and thus lead to lower quality. In contrast to the blade coating method, the maximum achievable coat weight by means of the film coating method is substantially lower. This limitation of the maximum coat weight is particularly pronounced at high coating speeds.

The two coating methods described, both the film press coating method and the blade press coating method, have the inherent disadvantage that the coat weight between elevations and depressions (peaks and vales), which the surface of the paper substrate has, is nonuniformly distributed so that the printing ink acceptance is likewise nonuniformly distributed, which may lead to the mottling effect (cloudiness of the print) already described above.

Since, however, a relatively high coating speed which is substantially above 600 m/min can be achieved by both methods, both the film press coating method and the blade coating method are very widely used in the production of graphic arts papers.

The Japanese Patent Applications JP 94-89437, JP 93-311931, JP 03-177816, JP 93-131718, JP 92-298683, JP 92-51933, JP 01-298229, JP 90-217327, JP 8-310110 and EP-A 517 223 and EP-A 1 249 533 have already disclosed the use of the curtain coating method for coating a substrate with one or more pigmented coating slips.

The use of the curtain coating method for converting substrates, for example paper and cardboard, as already disclosed in the abovementioned publications, leads to an improvement in the quality of the coated surface structure in comparison with coating methods used to date, such as the film press method or the blade coating method. A curtain coating method is, however, disadvantageous since the applied liquid curtain tends to instability at high coating speeds and low coat weights. In addition, an occurrence of the coating slip composition applied by the curtain coating method on the surface of the paper substrate, the coating slip is deflected by about 90° from free fall and is thereby accelerated to the substrate speed, which leads to locally very high shear and strain rates in the coating slip fluid. In an extreme case, the fluid can be subjected to excessive stress so that tearing of the film by cavitation bubbles may occur. The danger of tearing of the applied coating slip curtain increases with increasing speed of the substrate and represents the upper operating limit for the curtain coating method.

The anchoring of the copying coat to the surface of the paper substrate is a further critical parameter in the curtain coating method for a coating slip composition to be applied to a substrate surface. Insufficient anchoring of the paper coat to the surface of the substrate may lead to poor print quality in rotary offset or in the sheet-fed offset printing process.

In view of the disadvantages afflicting the prior art solutions, it is an object of the present invention to provide a coating slip composition which can be applied by the curtain coating method and which has considerably improved binding power of the pigmented coating slip compositions.

### BRIEF SUMMARY OF THE INVENTION

In line with the present invention, a binder based on styrene/butadiene is added to a coating slip composition which can be applied by the curtain coating method. The binder is selected on the basis of styrene/butadiene latex binders, styrene/acrylate latex binders, styrene/butadiene/acrylonitrile latex binders, styrene/maleic anhydride binders and styrene/acrylate/maleic anhydride binders having a particle size of <130 nm.

Suitable binders mixed according to the invention with the coating slip composition are of course synthetic polymers. Starch may be mentioned as a natural polymer, and those polymers which are obtained by free radical polymerization of ethylenically unsaturated compounds (monomers) are particularly suitable as synthetic polymers.

The binder is preferably a polymer which comprises at least 40, preferably at least 60, particularly preferably at least 80, % by weight of main monomers. The main monomers are selected from C₁-C₂₀-alkyl (meth)acrylates, vinyl esters of carboxylic acids of up to 20 carbon atoms, vinylaromatics of up to 20 carbon atoms, ethylenically unsaturated nitriles, vinyl halides, vinyl ethers of alcohols of 1 to 10 carbon atoms, aliphatic hydrocarbons having 2 to 8 carbon atoms and one or two double bonds or mixtures of these monomers. Examples are alkyl (meth)acrylates having a C₁-C₁₀-alkyl radical, such as methyl methacrylate, methyl acrylate, n-butyl acrylate, ethyl acrylate and 2-ethylhexyl acrylate. In particular, mixtures of the alkyl (meth)acrylates may also be suitable. Furthermore, vinyl esters of carboxylic acids of 1 to 20 carbon atoms, e.g. vinyl laurate, vinyl stearate, vinyl propionate, vinyl versatate and vinyl acetate.

Suitable vinylaromatic compounds are vinyltoluene, α- and p-methylstyrene, α-butylstyrene, 4-n-butylstyrene, 4-n-decylstyrene and preferably styrene. Examples of nitriles are acrylonitrile and methacrylonitrile.

Vinyl halides are ethylenically saturated compounds substituted by chlorine, fluorine or bromine, vinyl chloride and vinylidene chloride being mentioned in particular.

Examples of vinyl ethers are vinyl ethyl ether and vinyl isobutyl ether. Vinyl ethers with alcohols of 1 to 4 carbon atoms are preferably used.

Examples of hydrocarbons having 2 to 8 carbon atoms and one or two olefinic double bonds are ethylenepropylenebutadieneisoprene and chloropropene.

Preferred main monomers are C₁-C₁₀-alkyl (meth)acrylates and mixtures of the alkyl (meth)acrylates with vinylaromatics, in particular styrene or hydrocarbons having double bonds, in particular butadiene, or mixtures of such hydrocarbons with vinylaromatics, in particular styrene.

In the case of mixtures of aliphatic hydrocarbons (in particular butadiene) with vinylaromatics (in particular styrene), the ratio may be, for example, from 10:90 to 90:10, in particular from 20:80 to 80:20.

Preferably used main monomers are butadiene and the above mixtures of butadiene and styrene (polystyrenebutadiene for short) or C₁-C₁₀-alkyl (meth)acrylates or mixtures thereof with styrene (polyacrylates for short).

In addition to the main monomers, the polymer may contain further monomers, for example monomers with carboxylic acid, sulfonic acid or phosphonic acid groups. Carboxyl groups are preferably used. Examples are acrylic acid, methacrylic acid, itaconic acid, maleic acid or fumaric acid. The content of ethylenically unsaturated acids in the emulsion polymer is in general less than 5% by weight.

Further monomers are, for example, hydroxyl-containing monomers, in particular C₁-C₁₀-hydroxyalkyl (meth)acrylates and (meth)acrylamide.

According to a preferred embodiment, the preparation of the polymers is effected by emulsion polymerization, and the result is therefore an emulsion polymer. The preparation can, however, also be effected by solution polymerization and subsequent dispersing in water.

In the emulsion polymerization, ionic and/or nonionic emulsifiers and/or protective colloids or stabilizers are used as surface-active compounds. The surface-active substance is usually used in amounts of from 0.1 to 10% by weight, based on the monomers to be polymerized. Water-soluble initiators for the emulsion polymerization are two ammonium and alkali metal salts of peroxodisulfuric acid, e.g. sodium peroxodisulfate hydrogen peroxide or organic peroxides e.g. tert-butyl hydroperoxide. Reduction oxidation (redox) initiator systems are also suitable.

The amount of the initiators is in general from 0.1 to 10, preferably from 0.5 to 5, % by weight, based on the monomers to be polymerized. It is also possible to use a plurality of different initiators in the emulsion polymerization.

In the polymerization, it is possible to use regulators, for example in amounts of from 0 to 0.8 part by weight, based on 100 parts by weight of the monomers to be polymerized, by means of which the molar mass is reduced. For example, compounds having a thiol group, such as tert-butyl mercaptan, thioglycolic acid ethyl acrylic ester, mercaptoethynol, mercaptopropyltrimethoxylan or tert-dodecyl mercaptan, are suitable.

The emulsion polymerization is effected as a rule at from 30° C. to 130° C., preferably from 50° C. to 90° C. The polymerization medium may consist either only of water or of mixtures of water and liquids miscible therewith such as methanol. Preferably, however, only water is used. The emulsion polymerization can be carried out both as a batch process and in the form of a feed process, including a step or gradient procedure. However, the feed process in which a part of the polymerization batch is initially taken, heated to the polymerization temperature and partly polymerized and then the remainder of the polymerization batch is fed to the polymerization zone, usually via a plurality of spatially separated feeds, one or more of which contain the monomers or in emulsified form, continuously, stepwise or with superposition of a concentration gradient, while maintaining the polymerization, is preferred. In the polymerization, it is also possible initially to take a polymer, for example for better establishment of the particle size.

The manner in which the initiator is added to the polymerization vessel in the course of the free radical aqueous emulsion polymerization is known. It may be either completely initially taken in the polymerization vessel or used continuously or stepwise at the rate of its consumption in the course of the free radical aqueous emulsion polymerization. Specifically, this depends on the chemical nature of the initiator system and on the polymerization temperature. Preferably, a part is initially taken and the remainder is fed in at the rate of consumption in the polymerization zone.

For removing the residual monomers, an initiator is usually also added after the end of the actual emulsion polymerization, i.e. after a conversion of the monomers of at least 95%. The individual components may be added to the reactor in the feed process from above, from the side or from below through the reactor bottom. In the emulsion polymerization, aqueous dispersions of the polymer, as a rule having solids contents of from 15 to 75, preferably from 40 to 75, % by weight, are obtained.

The binder added to the coating slip composition and based on styrene/butadiene latex binder, styrene/acrylate latex binder, styrene/butadiene/acrylonitrile latex binder, styrene/maleic anhydride binder, styrene/acrylate/maleic anhydride binder or polyvinyl acetate has a particle size of <130 nm.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a diagram which shows the dependence of the binding power on the particle size and

FIG. 2 shows the influence size of the binder on the ink density after a defined time span.

### DETAILED DESCRIPTION OF THE PREFERRED EMBODIMENTS

Referring now to the drawings, wherein like reference numerals designate identical or corresponding parts throughout the several views.

### Coating Slip Composition

The coating slip composition proposed according to the invention (% data and amounts by weight) comprises a slurry of calcium carbonates CaCO₃ having a particle size of 2 μm, which accounts for 95% of the slurry (e.g. Hydrocarb 95 ME, available from OMYA, Oftringen, Switzerland), having a solids content of 77%, and a clay slurry of Amazon Premium having a particle size of 2 μm, which accounts for 98% of the slurry (for example Amazon Premium, available from Kaolin International), having a solids content of 74.6%.

In the examples below, different binders A, B, C, D, E, F, G, H and I are mixed with the coating slip composition.

These are specifically:

Binder A is a styrene/butadiene latex (Styronal D 536 from BASF AG) having a particle size of 130 nm, Tg 0° C. and 50% in water. Tg is the glass transition temperature, and the gel content is 83%.

Binder B is a styrene/butadiene/acrylonitrile latex (Styronal D 627 from BASF AG) having a particle size of 140 nm, Tg 13° C., 50% in water. Tg is the glass transition temperature, and the gel content is 80%.

Styrene/butadiene latex (Styronal D 808 from BASF AG) having a particle size of 160 nm, Tg 22° C. and 50% in water, is used as binder C. Tg is the glass transition temperature, and the gel content is 72%.

Styrene/butadiene latex having a particle size of 130 nm, Tg 0° C., 50% in water, was used as a further binder, i.e. binder D, neutralized in sodium hydroxide solution. Tg is the glass transition temperature, and the gel content is 82%.

Styrene/butadiene latex having a particle size of 165 nm and a Tg of 16° C., 50% in water, is used as binder E. Tg is the glass transition temperature.

A further binder, binder F, is styrene/butyl acrylate latex, which has a particle size of 175 nm a Tg of 20° C. and is 50% in water.

A further binder, binder G, is styrene/butadiene latex, which has a particle size of 115 nm, a Tg of 0° C. and a solids content of 50%, and the gel content is 85%.

A further binder, binder H, is styrene/butadiene latex, which has a particle size of 100 nm, a Tg of 0° C. and a solids content of 50%, and the gel content is 76%.

A further coating slip composition included a binder I, i.e. styrene/butadiene/acrylonitrile latex having a particle size of 80 nm and a glass transition temperature Tg of −12° C., 50% in water, the gel content being 86%.

A polyacrylamide thickener (composition 40 mol % of acrylic acid, 60 mol % of acrylamide, molecular weight Mn 44 million) was added as additive A and a surfactant, i.e. an aqueous solution of sodium dialkylsulfosuccinate (Lumiten I-DS 3525), available from BASF AG, and an optical brightener, for example Blancophor P, available from Bayer AG, Leverkusen, were added to all coating slip compositions comprising the different binders A to I.

The pH of the pigmented coating slip compositions was brought to 8.7 by adding 10% strength NaOH. The solids content of coating slip formulations was established by dilution with water.

### Table 1 Below Gives an Overview of the Formulations.

| | Formulation | | | | | | | | |
|---|---|---|---|---|---|---|---|---|---|
| | 1 | 2 | 3 | 4 | 5 | 6 | 7 | 8 | 9 |
| Hydrocarb 95 | 70 | 70 | 70 | 70 | 70 | 70 | 70 | 70 | 70 |
| Amazon Premium | 30 | 30 | 30 | 30 | 30 | 30 | 30 | 30 | 30 |
| Binder A | 12 | | | | | | | | |
| Binder B | | 12 | | | | | | | |
| Binder C | | | 12 | | | | | | |
| Binder D | | | | 12 | | | | | |
| Binder E | | | | | 12 | | | | |
| Binder F | | | | | | 12 | | | |
| Binder G | | | | | | | 12 | | |
| Binder H | | | | | | | | 12 | |
| Binder I | | | | | | | | | 12 |
| Additive A | 0.11 | 0.11 | 0.11 | 0.11 | 0.11 | 0.11 | 0.11 | 0.11 | 0.11 |
| Optical brightener | 0.5 | 0.5 | 0.5 | 0.5 | 0.5 | 0.5 | 0.5 | 0.5 | 0.5 |
| Surfactant | 0.3 | 0.3 | 0.3 | 0.3 | 0.3 | 0.3 | 0.3 | 0.3 | 0.3 |
| Solids content (%) | 66.8 | 66.6 | 66.9 | 66.8 | 66.5 | 66.8 | 66.9 | 66.8 | 66.8 |
| Viscosity (100 rpm) | 640 | 480 | 530 | 560 | 530 | 440 | 468 | 800 | 538 |
| Spindle No. 4 | | | | | | | | | |
| pH | 8.8 | 8.8 | 8.8 | 9.0 | 9.4 | 8.6 | 8.5 | 8.8 | 8.5 |

Table 1 shows that the formulations 1 to 9 of the coating slip composition in each case differ from one another as a result of the admixed binders A, B, C, D, E, F, G, H and I.

The Brookfield viscosity of the formulations 1 to 9 was measured by means of a Brookfield RVT viscometer (available from Brookfield Engineering Laboratories, USA) at a room temperature of 25° C. For the measurement, 600 ml of the dispersion were introduced into a 11 beaker and the viscosity was measured using a spindle No. 4 at a speed of 100 rpm.

The coating slip composition according to the formulations 1 to 9 were applied as a coating to the substrates according to the examples given below. The properties of the substrates contained, whether paper or cardboard, were determined on the basis of the following test protocols.

### Paper Gloss

Paper gloss is measured at an angle of incidence of 75°. according to DIN 54 502.

### Particle Size

The particle size of the dispersions was determined according to DIN ISO 13321.

Glass Transition Temperature Tg

The glass transition temperature of dispersion films was determined according to DIN ISO 53765.

Prüfbau Offset (PB)

The test apparatus comprises a Prüfbau printability tester MZ II, a Prüfbau inking roller, metal printing disks, in each case 40 mm wide, an application pipette with which 0.01 ml can be metered and a further application pipette with which 0.001 ml can be metered and a longitudinal proof support and a stopwatch.

The printing ink used was Novavit 4F 713 Cyan (Kast & 3Ehinger). Samples measuring 240 ml by 46 ml are cut in the longitudinal direction from the papers to be tested. The samples are stored separately from one another in a conditioning room for at least 15 hours before the test.

For carrying out the test, the apparatus is switched on, 0.3 ml of the printing ink being applied to one of the inking rollers and a run lasting for 1 minute then being carried out. A printing disk is then inserted into a holder provided for this purpose and is inked for 30 seconds. For each further printing disk, 0.03 ml of the printing ink is applied to the inking roller, followed by a run lasting for 30 seconds, before inking is carried out. The inked inking roller can be used only for a certain time span. The nip pressure is brought to 800 Newton (=200 Newton/cm), and the printing speed is 1 m/s. A paper strip is clamped on a proof support and placed in the channel up to the stop before the right printing unit. The inked printing disk is mounted on the right printing unit core and the printing process is started by pressing the start button. If the hiding power was not reached with the abovementioned amount of printing ink, the amount of printing ink and its supply must be increased from 0.4 and 0.04 ml, and 0.5 and 0.05 ml, respectively. The test is continued only when the hiding power was reached in the case of the paper strip. The proof support is brought into the starting position with the printed paper strip. Care should be taken to ensure that the strip is not touched with the fingers or other articles. After a specified time span, as a rule 10 s, the printing process is started again without replacement of the printing disk. This is repeated five times altogether.

After each pass, the picking on the printed side of the paper strip is visually assessed. If no picking occurs after six printing operations, the determination of the tendency to pick is continued at longer time intervals, for example 20s or 30 s. The printing disks used and the inking rollers are cleaned in each case with heavy naphtha before being used the next time and are then dried using a cotton cloth. The result obtained (passes to fail) is expressed in the number of print operations until the occurrence of the initial picking, the ink application in ml and the time interval between individual passes in seconds.

### Substrate Roughness

The roughness of the coated substrates was determined by means of a Parker PrintSurf roughness tester. A sample of coated paper is clamped between a Cork-Melinex plate and a measuring head at a pressure of 1000 kPa. Compressed air is applied to the substrate at a defined pressure of 400 kPa, and the leakage of the air between the measuring head and the paper surface is then measured. High air leakage indicates high paper roughness of the coated substrate, whether paper or cardboard.

### Coat Uniformity

The substrate sample to be tested is immersed completely for one minute in a neocarmine solution MS “FesagO” (available from Merck, Darmstadt). The substrate sample to be tested is then washed under running tap water until color is no longer detectable. The sample is then squeezed between two filter papers and then dried in a laboratory dryer at a temperature of 90° C. The appearance of the stained coat surface is visually assessed.

### Adjustment of Coat Weight

The coat weight of the coating slip to be applied to the substrate to be coated, whether paper or cardboard, by means of the curtain coating method was determined in each coating experiment on the basis of the volume flow rate of the coating slip curtain through a curtain coating aggregate nozzle, the paper web speed, the density of the coating slip composition and the width of the coated substrate.

The coated substrates were then calendered using a Janus calender (from Voith) under the following conditions:

| | |
|---|---|
| Speed: | 710 m/min |
| Line load: | 138 N/mm |
| Surface temperature: | 120° C. |

### Determination of Gel Content

A film having a film thickness of about 1 to 2 mm is cast from the dispersion. This film is dried for 72 h at room temperature. 3 squares having a side length of 1 cm are then cut out from the film obtained and are weighed. Each piece is placed in a closed vessel which comprises 30 ml of THF. After 48 h, the films are freed from the solvent over a weighed metal screen. The screen with the polymer film is then dried, which is effected at 80° C. for 2 h, and the individual films are reweighed. The gel content is determined from the weight quotient (weight after washing/original weight).

### Ink Density/Absorption Behavior

The assessment can also be carried out by ink density measurement. If the ink transfer to a counter-strip does not have cloudy structures, the ink density of individual segments on it is measured using a densitometer at 10 points in each case. Optionally, the ink density can be plotted against the absorption time at a time after printing when the counter-strip was printed. The relative ink density RF in % is obtained as the result of an evaluation using a densitometer. According to the following relationship

RF=100 DM/DV where
RF=Relative ink density %
DM=Mean of the measured values of the ink density on a segment of both test strips
DV=Mean of the measured values of the ink density of the printed counter-strip.

The result is reproduced by the ink density on the printed counter-strip to two places of decimal, against absorption time (time interval in s).

### Example 1

Formulation 1 comprising binder A was applied to a wood-free base paper having a weight of 58 g/m² by means of simple curtain coating of this substrate. The coat weight is 15 g/m² at a substrate web speed of 1000 m/min.

### Example 2

Formulation 2 of the coating slip composition comprising binder B was applied to a wood-free substrate having a weight of 58 g/m² by means of simple curtain coating of its surface with a coat weight of 15 g/m² at a paper web speed of 1000 m/min.

### Example 3

The coating slip composition according to formulation 3 comprising binder C was likewise applied to a wood-free substrate having a weight of 58 g/m² by means of simple curtain coating of its surface. The coat weight was 15 g/m² at a paper speed of, likewise, 1000 m/min.

### Example 4

According to this example, a coating slip composition according to formulation D was applied by simple curtain coating to a wood-free base substrate having a weight of 58 g/m² in a coat weight of 15 g/m², the substrate web speed likewise being 1000 m/min.

### Example 5

According to this example, a coating slip composition according to formulation F in table 1 comprising binder E was applied to a wood-free base substrate having a weight of 58 g/m² by means of simple curtain coating of its surface, a coat weight of 15 g/m² being established and the substrate web speed being 1000 m/min.

### Example 6

In example 7, a coating slip composition according to formulation 7 comprising binder F was applied to wood-free base substrate having a weight of 58 g/m² by means of simple curtain coating of its surface, a coat weight of 15 g/m² being established and the substrate web speed likewise being a 1000 m/min.

### Example 7

According to this example, a coating slip composition according to formulation 8 comprising binder G was applied to a wood-free base substrate having a weight of 58 g/m² by means of simple curtain coating of its surface, the coat weight being brought to 15 g/m² at a substrate web speed of 1000 m/min.

### Example 8

According to this example, a coating slip composition according to formulation 9 comprising binder H was applied to a wood-free base substrate having a weight of 58 g/m² by means of simple coating of the substrate surface with a coat weight of 15 g/m², a substrate web speed of 1000 m/min having been established.

### Example 9

According to this example, a coating slip composition according to formulation 10 comprising binder I was applied to a wood-free base substrate having a weight of 58 g per square meter by means of simple curtain coating of the substrate surface with a coat weight of 15 g/m², a substrate web speed of 1000 m per min having been established.

The substrates coated according to examples 1 to 9 were then calendered using a Janus calender (from Voith) under the following conditions:

| | |
|---|---|
| Speed: | 710 m/min |
| Line load: | 138 N/mm |
| Surface temperature: | 120° C. |

After the calendering, the coated substrates coated according to examples 1 to 9 and then calendered under the above operating parameters had the following properties:

TABLE 2
Overview of paper properties of the calendered papers

| | | | | Gloss | | | | | |
|---|---|---|---|---|---|---|---|---|---|
| | | Gloss | | Lehmann | | Roughness | | | |
| | | Gardner | | 75° Tappi | | PPS-10S | | | |
| Example | Moisture | [%] | | [%] | | [m²] | | Thickness | Bulk |
| No. | [%] | US | LS | US | LS | US | LS | [μm] | [cm³/g] |
| 1 | 4.36 | 71 | 71 | 69.6 | 69.5 | 1.40 | 1.25 | 69.25 | 0.785 |
| 2 | 4.31 | 74 | 73 | 70.1 | 70.5 | 1.28 | 1.22 | 69.50 | 0.779 |
| 3 | 4.07 | 74 | 75 | 71.5 | 70.7 | 1.34 | 1.20 | 70.00 | 0.790 |
| 4 | 4.5 | 74 | 73 | 71.1 | 70.4 | 1.20 | 1.19 | 71.25 | 0.790 |
| 5 | 4.34 | 74 | 72 | 71.3 | 69.7 | 1.39 | 1.44 | 70.00 | 0.791 |
| 6 | 4.39 | 72 | 73 | 71.2 | 69.9 | 1.28 | 1.22 | 69.25 | 0.775 |
| 7 | 4.81 | 75 | 73 | 71.1 | 69.1 | 1.30 | 1.14 | 70.75 | 0.785 |
| 8 | 4.68 | 73 | 72 | 70.4 | 69.5 | 1.21 | 1.20 | 70.75 | 0.775 |
| 9 | 4.53 | 70 | 68 | 66.5 | 65.0 | 1.37 | 1.27 | 70.75 | 0.78 |

TABLE 3
Overview of results for examples 1 to 9
The results according to tables 2 and 3 clearly show that, in order
to achieve high binding powers between the upper side of the
substrate to be coated by the curtain coating method, such as paper
or board, and a coating slip composition applied to the upper side
thereof, high binding powers are obtained when particularly finely
divided binders having a particle size of <130 nm are used.

| | Formulation | | | | | | | | |
|---|---|---|---|---|---|---|---|---|---|
| | 1 | 2 | 3 | 4 | 5 | 6 | 7 | 8 | 9 |
| Prufbau Off-Set | 4 | 5 | 3.5 | 3.5 | 4.0 | 4.5 | 6 | 6 | >6 |
| (Passes to fail) | | | | | | | | | |
| US (10 s) | | | | | | | | | |
| Prufbau Off-Set | 3.5 | 5 | 4 | 4 | 5.0 | 4 | 6 | 6 | >6 |
| (Passes to fail) | | | | | | | | | |
| LS (10 s) | | | | | | | | | |

### Comparative Example Binding Power in Blade Coating Method

Table 4 below gives an overview of a formulation which was applied by the blade coating method to a substrate.

TABLE 4
Overview of blad-coated formulation (Reference formulation)

| Formulation | 1 |
|---|---|
| CaCO₃ (Hydrocarb 95) | 70 |
| Amazon Premium | 30 |
| Binder A (Styronal D 536) | 12 |
| Poylsalz S | 0.3 |
| Finfix 10 | 0.4 |
| Omrelub CD | 0.5 |
| Blancophor P | 0.5 |
| Solids content | 66.0 |
| Brookfield viscosity (spindle No. 4) | 1100 mPas |
| pH | 9.0 |

### Comparative Example 1

The formulation with the number 1 was applied to a wood-free 58 g/m² base paper by means of a conventional blade coating method on the substrate in a coat weight of 15 g/m at a paper web speed of 1200 m/min.

The substrates coated according to reference example 1 were then calendered using a Janus calendar (from Voith) under the following conditions:

| | |
|---|---|
| Speed: | 710 m/min |
| Line load: | 138 N/mm |
| Surface temperature: | 120° C. |

After the calendering, the substrates coated according to reference example 1, coated papers then calendered under the above operating parameters have the following paper properties.

The results obtained are summarized in table 5 shown below.

TABLE 5
Overview of results for example from reference experiments

| Formulation | 1 |
|---|---|
| Smoothness - PPS US/LS | 1.0/1.1 |
| Prüfbau Off-Set (Passes to fail) | 5 |
| US - 30 seconds | |
| Prüfbau Off-Set (Passes to fail) | 5 |
| LS - 30 seconds | |
| Moisture | 4.4 |
| Gloss Lehmann 75° Tappi [%] US | 74 |
| Gloss Lehmann 75° Tappi [%] LS | 72 |
| Bulk [cm³/g] | 0.779 |

The results shown in table 5 show that the binding power in the case of blade papers is significantly higher than papers coated by the curtain coating method, with otherwise good paper properties.

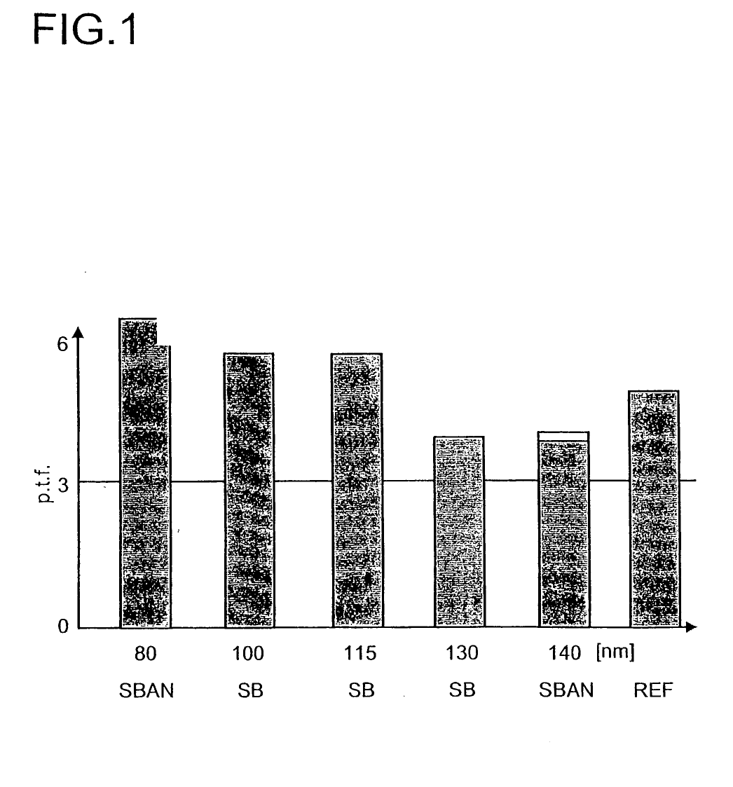

FIG. 1 shows a diagram which shows the relationship between particle size and resulting binding power of a coating slip composition.

The number of passes of a paper sample according to the abovementioned Prüfbau offset until an initial picking occurs is shown along the ordinate. Various binder particle sizes are plotted along the X axis (abscissa). The diagram according to FIG. 1 shows that the binding power of a coating slip composition decreases with increasing particle size. For example, the coating slip composition which contains a binder based on styrene/butadiene/acrylonitrile (SBAN) having a particle size of 80 nm achieves a larger number of passes before picking occurs (over six passes), while a coating slip composition which comprises a binder (SBAN) having a particle size of 140 nm achieves only four passes (10 s) before the picking begins. FIG. 1 also shows the number of passes of coating slip compositions in which a styrene/butadiene-based binder had been incorporated. At a particle size of 100 nm and 115 nm, six passes were possible before picking occurred, whereas at a particle size of 130 nm only 45 passes could be achieved.

In the case of a coating slip composition which contained formulation 1 comprising binder A, picking begins in the case of papers coated by curtain coating at only four passes (10 second value), whereas five passes are achieved in 30 seconds in the case of blade-coated papers.

In the case of curtain coating, binders having a smaller particle size of less than 130 nm can be used because, in the curtain coating method, no pressure pulse is exerted on the substrate, which produces migration in the base paper and thus results in a poorer binding power and less anchoring. Owing to the lack of a pressure pulse in the curtain coating method, the coating slip composition is not pressed into the base paper.

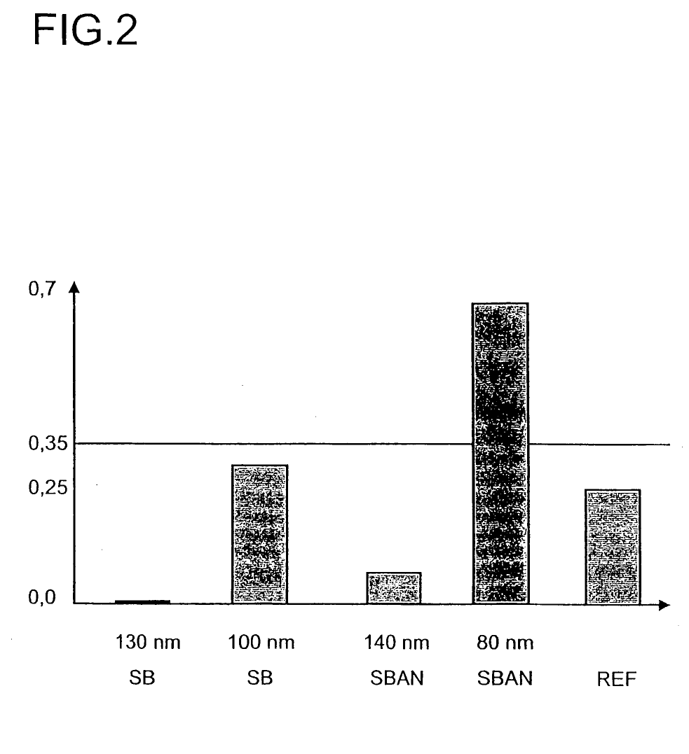

The diagram according to FIG. 2 shows the influence of the binder on the ink density.

The ink density at an absorption time of 120 s is plotted along the Y axis (ordinate), while the particle sizes of the binder used are plotted along the X axis (abscissa). The diagram according to FIG. 2 shows that that ink density after an absorption time of 120 s in the case of coating slip compositions which have a binder based on styrene/butadiene/acrylonitrile (SBAN) having a particle size of 140 nm remains considerably below the ink density which can be achieved with a coating slip composition which has a binder (SBAN) having a particle size of 80 nm. In the case of coating slip compositions which contain a binder based on styrene/butadiene (SB) having a particle size of 100 nm or 130 nm, the achievable ink density after 120 s for the coating slip composition having a particle size of 100 nm is about 0.3, while the coating slip composition which has an SB binder having a particle size of 130 nm is considerably below this.

The diagram according to FIG. 2 shows that an SBAN binder having a particle size of 80 nm leads to a very high ink density which is considerably above the ink density according to the reference experiment, and an SB binder having a particle size of 100 nm likewise leads to a good ink density which is still above the ink density achieved in the reference experiment.

Obviously, numerous modifications and variations of the present invention are possible in light of the above teachings. It is therefore to be understood that within the scope of the appended claims, the invention may be practiced otherwise than as specifically described herein.

1. A method of producing single or multiple coated substrates, comprising coating the substrate with one or more free falling liquid curtains obtained from a coating slip composition, wherein the coating slip composition comprises a binder comprising at least one selected from the group consisting of styrene/butadiene latex binders, styrene/acrylate latex binders, styrene/butadiene/acrylonitrile latex binders, styrene/maleic anhydride binders, styrene/acrylate/maleic anhydride binders; and the binder has a particle size of ≦5130 nm.

2. The method according to claim 1, wherein the binder comprising styrene/butadiene and styrene/butadiene/acrylonitrile has a gel content of from 10 to 95%.

3. The method according to claim 2, wherein the binder comprising styrene/butadiene and styrene/butadiene/acrylonitrile have a gel content of from 70 to 90%.

4. The method according to claim 1, wherein the coating slip composition comprises an organic or inorganic pigment.

5. The method according to claim 1, wherein the coating slip composition comprises polyacrylamides having a molecular weight Mw of from 1 to 50 million.

6. The method according to claim 1, wherein the coating slip composition has a Brookfield viscosity of from 20 to 5000 mPa·s.

7. The method according to claim 1, wherein a coat weight of the coating slip composition is from 0.1 to 50 g/m², based on the dry weight thereof on the substrate.

8. The method according to claim 4, wherein the pigment comprises at least one selected from the group comprising clay, kaolin, talc, calcium carbonate, titanium dioxide, satin white, synthetic polymer pigments, zinc oxide, barium sulfate, gypsum silica, aluminum and trihydrate.

9. The method according to claim 1, wherein the binder additionally comprises one or more of polysaccharides, proteins, polyvinylpyrrolidones, polyvinyl alcohols, cellulose and cellulose derivatives.

10. The method according to claim 1, wherein the coating slip composition applied has barrier properties against diffusion and has either release properties or adhesive properties.

11. The method according to claim 1, wherein the coating slip composition applied additionally comprises one or more polymers comprising ethylene/acrylic acid waxes, and/or silicones.

12. The method according to claim 1, wherein the substrate is base paper or cardboard.

13. The method according to claim 6, wherein the coating slip composition has a Brookfield viscosity from 20 to 2000 mPa·s.

14. The method according to claim 13, wherein the coating slip composition has a Brookfield viscosity from 20 to 1300 mPa·s.

15. The singly or multiply coated substrate obtained by the method according to claim 1.
